(19) United States
(12) Patent Application Publication
(10) Pub. No.: US 2024/0177072 A1
(43) Pub. Date: May 30, 2024

(54) RESERVATION SYSTEM, NOTIFICATION DEVICE, AND RESERVATION METHOD

(71) Applicant: TOYOTA JIDOSHA KABUSHIKI KAISHA, Toyota-shi (JP)

(72) Inventors: Mitsuaki TOMITA, Toyota-shi (JP); Hiroshi Ashida, Nukata-gun (JP); Kenji Tahara, Toyota-shi (JP); Tamaki Ozawa, Toyota-shi (JP); Takenori Shimizu, Inuyama-shi (JP); Tetsuro Kuniyoshi, Nagoya-shi (JP)

(73) Assignee: TOYOTA JIDOSHA KABUSHIKI KAISHA, Toyota-shi (JP)

(21) Appl. No.: 18/369,978

(22) Filed: Sep. 19, 2023

(30) Foreign Application Priority Data
Nov. 25, 2022 (JP) 2022-188368

(51) Int. Cl. G06Q 10/02

(52) U.S. Cl. CPC G06Q 10/02

(57) ABSTRACT

A reservation system is configured to make a reservation for a charging device configured to charge a vehicle. The reservation system includes a first processing unit configured to manage reservation time frames of the charging device available to a user of a shop, a second processing unit configured to manage providing time frames of a service from a service representative who provides the service to the user at the shop, and a third processing unit configured to execute a process for receiving a time frame of reservation desired by the user among time frames overlapping between available reservation time frames and available providing time frames based on the reservation time frames of the charging device managed by the first processing unit and the providing time frames of the service from the service representative managed by the second processing unit.

### CROSS-REFERENCE TO RELATED APPLICATION

This application claims priority to Japanese Patent Application No. 2022-188368 filed on Nov. 25, 2022, incorporated herein by reference in its entirety.

### BACKGROUND

### 1. Technical Field

The present disclosure relates to a reservation system, a notification device, and a reservation method, and more particularly, to a reservation system configured to make a reservation for a charging device that charges a vehicle, a notification device, and a reservation method in a reservation system including at least one computer configured to make a reservation for a charging device that charges a vehicle.

### 2. Description of Related Art

There is a reservation system for a charging device for charging a battery of an electrified vehicle such as a battery electric vehicle (hereinafter also referred to as “BEV”) (see, for example, WO2013/137071).

### SUMMARY

For example, a charging device may be installed in a parking lot for use of a shop such as a car dealer or a beauty salon. In the case of such shops, a specific service representative is assigned to a customer. In such a situation, the customer may want to receive a service from or communicate with the service representative of the shop in conjunction with the reservation for the charging device.

The present disclosure provides a reservation system, a notification device, and a reservation method that can be used to provide a service to a user from a service representative of a shop in conjunction with charging of a vehicle.

A reservation system according to the present disclosure is configured to make a reservation for a charging device configured to charge a vehicle. The reservation system includes a first processing unit configured to manage reservation time frames of the charging device available to a user of a shop, a second processing unit configured to manage providing time frames of a service from a service representative who provides the service to the user at the shop, and a third processing unit configured to execute a process for receiving a time frame of reservation desired by the user among time frames overlapping between available reservation time frames and available providing time frames based on the reservation time frames of the charging device managed by the first processing unit and the providing time frames of the service from the service representative managed by the second processing unit.

According to this configuration, the time frame of reservation desired by the user among the time frames overlapping between the available reservation time frames and the available providing time frames is received based on the managed reservation time frames of the charging device and the managed providing time frames of the service from the service representative. As a result, it is possible to provide the reservation system that can be used to provide the service from the service representative of the shop to the user in conjunction with the charging of the vehicle.

The third processing unit may be configured to execute a process for presenting a list of the time frames overlapping between the available reservation time frames and the available providing time frames to the user, a process for receiving selection of a time frame desired by the user from the list, and a process for presenting a selected time frame to the user as the reservation time frame and the providing time frame.

According to this configuration, the reservation system can be used to appropriately provide the service from the service representative of the shop to the user in conjunction with the charging of the vehicle.

The third processing unit may be configured to execute a process for presenting the providing time frame in which the service is providable by a service representative desired by the user in the list in a manner different from a manner for the providing time frame in which the service is providable by another service representative.

According to this configuration, the time frame in which the service is providable by the service representative desired by the user and the time frame in which the service is providable by another service representative can be presented to the user while being distinguished clearly.

The third processing unit may be configured to execute a process for presenting the providing time frame in which the service is providable by a service representative desired by the user in the list in a manner that is based on a certainty of provision of the service in the providing time frame.

According to this configuration, it is possible to present to the user whether the service is reliably providable in the providing time frame in which the service is providable by the service representative desired by the user.

The reservation system may further include a fourth processing unit configured to execute a process for giving more points to the user in a case where selection of a first time frame with a higher renewable energy ratio than a renewable energy ratio in another time frame from the list is received from the user than in a case where the selection of the first time frame is not received from the user.

According to this configuration, it is possible to prompt the user to make a reservation for the time frame with the higher renewable energy ratio.

According to another aspect of the present disclosure, a notification device is configured to notify a user of a shop about time frames overlapping between reservable time frames of a charging device for an electrified vehicle available to the user and providable time frames of a service from a service representative who provides the service to the user at the shop.

According to this configuration, it is possible to provide the notification device that can be used to provide the service from the service representative of the shop to the user in conjunction with the charging of the vehicle.

The notification device may be configured to give a notification about the providable time frame in which the service is providable by a service representative desired by the user in a manner different from a manner for the providable time frame in which the service is providable by another service representative.

According to this configuration, the time frame in which the service is providable by the service representative desired by the user and the time frame in which the service is providable by another service representative can be presented to the user while being distinguished clearly.

The notification device may be configured to give a notification about the providable time frame in which the service is providable by a service representative desired by the user in a manner that is based on a certainty of provision of the service in the providable time frame.

According to this configuration, it is possible to present to the user whether the service is reliably providable in the providable time frame in which the service is providable by the service representative desired by the user.

Still another aspect of the present disclosure relates to a reservation method in a reservation system including at least one computer configured to make a reservation for a charging device configured to charge a vehicle. The reservation method includes managing, by the at least one computer, reservation time frames of the charging device available to a user of a shop, managing, by the at least one computer, providing time frames of a service from a service representative who provides the service to the user at the shop, and executing, by the at least one computer, a process for receiving a time frame of reservation desired by the user among time frames overlapping between available reservation time frames and available providing time frames based on the managed reservation time frames of the charging device and the managed providing time frames of the service from the service representative.

According to this configuration, it is possible to provide the reservation method that can be used to provide the service from the service representative of the shop to the user in conjunction with the charging of the vehicle.

The at least one computer may be configured to, as the process for receiving the time frame of reservation desired by the user, execute a process for presenting a list of the time frames overlapping between the available reservation time frames and the available providing time frames to the user, a process for receiving selection of a time frame desired by the user from the list, and a process for presenting a selected time frame to the user as the reservation time frame and the providing time frame.

The at least one computer may be configured to, as the process for presenting the list to the user, execute a process for presenting the providing time frame in which the service is providable by a service representative desired by the user in the list in a manner different from a manner for the providing time frame in which the service is providable by another service representative.

The at least one computer may be configured to, as the process for presenting the list to the user, execute a process for presenting the providing time frame in which the service is providable by a service representative desired by the user in the list in a manner that is based on a certainty of provision of the service in the providing time frame.

The reservation method may further include executing, by the at least one computer, a process for giving more points to the user in a case where selection of a first time frame with a higher renewable energy ratio than a renewable energy ratio in another time frame from the list is received from the user than in a case where the selection of the first time frame is not received from the user.

According to the present disclosure, it is possible to provide the reservation system, the notification device, and the reservation method that can be used to provide a service to the user from the service representative of the shop in conjunction with the charging of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a reservation system according to embodiments:

FIG. 2 is a block diagram showing a schematic configuration of each device in the reservation system of the embodiments:

FIG. 3 is a flowchart showing a flow of a reservation process in a first embodiment:

FIG. 4 shows an example of an image including a list of available time frames overlapping between a charging device and service representatives in the embodiments: and

FIG. 5 is a flowchart showing flows of a service representative reservation process and a charging device reservation process in a second embodiment.

### DETAILED DESCRIPTION OF EMBODIMENTS

Hereinafter, embodiments of the present disclosure will be described in detail with reference to the drawings. The same or corresponding portions are denoted by the same signs throughout the drawings, and description thereof will not be repeated.

### First Embodiment

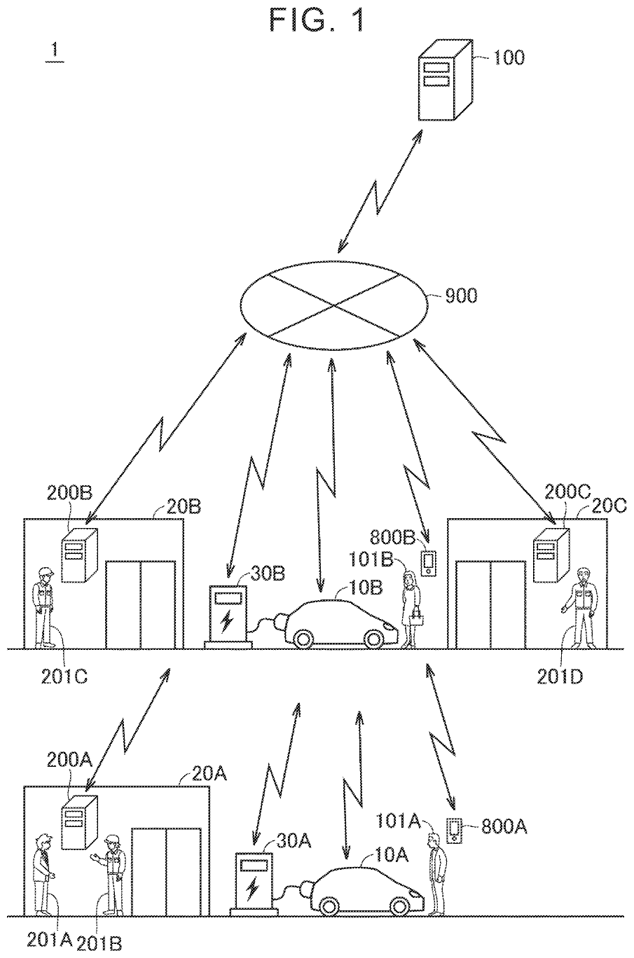

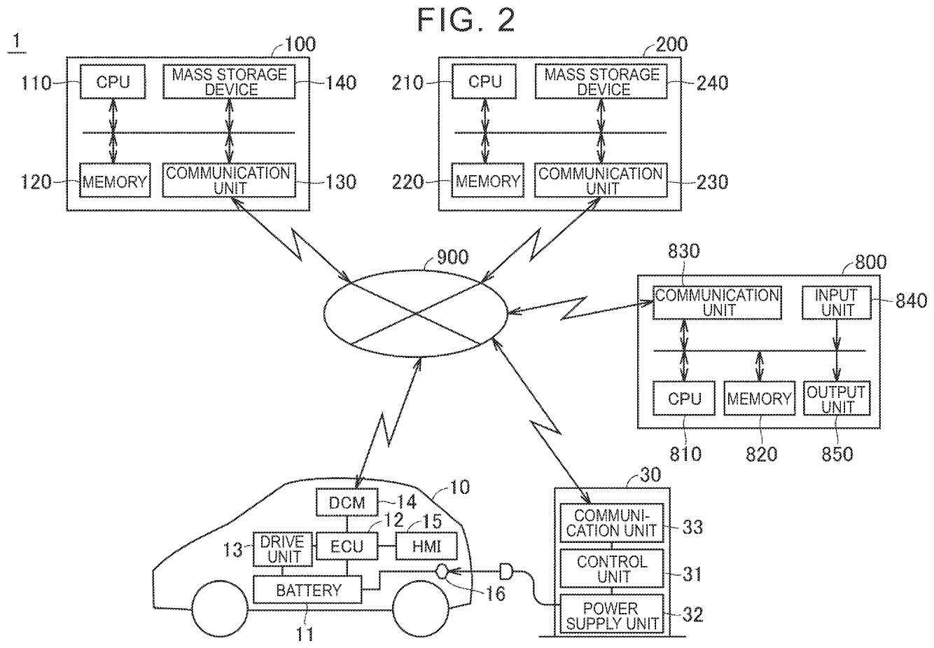

FIG. 1 shows the configuration of a reservation system 1 according to the embodiments. FIG. 2 is a block diagram showing a schematic configuration of each device in the reservation system 1 of the embodiments. Referring to FIGS. 1 and 2, the reservation system 1 includes a plurality of vehicles 10A, 10B (hereinafter also referred to representatively as “vehicles 10”), a plurality of shops 20A to 20C (hereinafter also referred to representatively as “shops 20”), shop servers 200A to 200C (hereinafter also referred to representatively as “shop servers 200”) provided in the shops 20A to 20C, respectively, charging devices 30A, 30B (hereinafter also referred to representatively as “charging devices 30”), and a management server 100. The reservation system I may further include mobile terminals 800A, 800B (hereinafter also referred to representatively as “mobile terminals 800”) of users 101A, 101B (hereinafter also referred to representatively as “users 101”) of the vehicles 10. The vehicles 10A, 10B, the shop servers 200A to 200C, the management server 100, the charging devices 30, and the mobile terminals 800 can communicate with each other via a communication network 900.

The vehicle 10 includes a battery 11, an electronic control unit (ECU) 12, a drive unit 13, a data communication module (DCM) 14, and a human-machine interface (HMI) 15. The battery 11 stores electric power to be used for traveling of the vehicle 10. The battery 11 is, for example, a lithium ion battery. The battery 11 is not limited to this, and may be any other type of battery such as a nickel-metal hydride battery or an all-solid-state battery.

The ECU 12 includes a central processing unit (CPU), a memory, and a global positioning system (GPS) receiver. The memory includes a random access memory (RAM) and a read only memory (ROM), and stores programs and data to be used by the CPU. The CPU executes predetermined processes prescribed by the programs based on the programs and data stored in the memory and data input from the outside, stores execution result data in the memory, and outputs the execution result data to the outside. The GPS receiver detects positional information of the vehicle 10 and transfers it to the CPU.

The drive unit 13 includes a motor generator and an inverter. The inverter drives the motor generator by using electric power in the battery 11, and charges the battery 11 with regenerated power from the motor generator. The drive unit 13 may further include an engine. The engine operates on fuel to drive the motor generator or the vehicle 10. That is, the vehicle 10 may be a battery electric vehicle (BEV) that includes a motor generator but does not include an engine, or may be a hybrid electric vehicle (HEV) or a plug-in hybrid electric vehicle (PHEV) that includes a motor generator and an engine. Alternatively, the vehicle 10 may be a fuel cell electric vehicle (FCEV).

The DCM 14 is a module for communicating with an external device via the communication network 900, and transmits data from the ECU 12 to the external device or transfers data from the external device to the ECU 12.

The HMI 15 is provided near a driver's seat of the vehicle 10. The HMI 15 is a device that receives information input by the user, outputs the information to the ECU 12, and notifies the user about information from the ECU 12 by display or voice. The HMI 15 includes, for example, a touch panel display.

The shops 20A to 20C include the shop servers 200A to 200C, respectively. Workers 201A, 201B (hereinafter also referred to representatively as “workers 201”) work at the shop 20A. The workers 201A, 201B are hereinafter also referred to as “service representative A” and “service representative B”, respectively. Workers 201C, 201D work at the shops 20B, 20C, respectively.

The charging device 30 includes a control unit 31, a power supply unit 32, and a communication unit 33. The power supply unit 32 converts electric power supplied from an external power supply such as a power system into electric power of a predetermined alternating or direct current voltage under control of the control unit 31. The power supply unit 32 supplies electric power for charging the battery 11 to the vehicle 10 via a cable of the charging device 30. The electric power from the power supply unit 32 via the cable of the charging device 30 is supplied to the vehicle 10 through a connector of the charging device 30 connected to an inlet 16 of the vehicle 10. The communication unit 33 is a module that communicates with an external device via the communication network 900. The communication unit 33 transmits data from the control unit 31 to the external device or transfers data from the external device to the control unit 31. The control unit 31 includes a CPU and a memory, and controls the power supply unit 32 and the communication unit 33. The charging device 30A is used exclusively for the shop 20A. The charging device 30B is shared by the shops 20B, 20C.

The shop server 200 includes a CPU 210, a memory 220, a communication unit 230, and a mass storage device 240. The memory 220 includes a random access memory (RAM) and a read only memory (ROM). The shop server 200 manages schedules of one or more workers 201. In the management of the schedules of the workers 201, inputs of dates and times and details of tasks of the workers 201 are received, and the dates and times, the workers 201, and the details of tasks are stored in the memory 220 or the mass storage device 240 in association with each other. In the management of the schedules of the workers 201, requested date and time and details of a requested task of the worker 201 are output from the memory 220 or the mass storage device 240 in response to a request. The shop server 200 may manage reservations for one or more charging devices 30. The communication unit 230 can communicate with an external device via the communication network 900 to transmit data from the CPU 210 to the external device or transfer data from the external device to the CPU 210. The mass storage device 240 is a hard disk drive (HDD), a solid state drive (SSD), or the like, and stores programs and data to be used by the CPU 210. The CPU 210 executes predetermined processes prescribed by the programs based on the programs and data stored in the memory 220 or the mass storage device 240 and data input to the communication unit 230 from an external device. The CPU 210 stores execution result data in the memory 220 or the mass storage device 240, and outputs the execution result data from the communication unit 230 to the external device.

The management server 100 includes a CPU 110, a memory 120, a communication unit 130, and a mass storage device 140. The management server 100 manages reservations for the charging devices 30 in the reservation system 1. In the reservation management, inputs of dates and times and reservations for the charging devices 30 are received from persons who make reservations, and the dates and times, the charging devices 30, and the persons who make reservations are stored in the memory 120 or the mass storage device 140 in association with each other. In the reservation management, requested date and time and details of a requested reservation for the charging device 30 are output from the memory 120 or the mass storage device 140 in response to a request. The functions of the CPU 110, the memory 120, the communication unit 130, and the mass storage device 140 of the management server 100 are similar to the functions of the CPU 210, the memory 220, the communication unit 230, and the mass storage device 240 of the shop server 200, respectively.

The mobile terminal 800 includes a CPU 810, a memory 820, a communication unit 830, an input unit 840, and an output unit 850. The functions of the memory 820 and the communication unit 830 of the mobile terminal 800 are similar to the functions of the memory 220 and the communication unit 230 of the shop server 200, respectively. The input unit 840 includes a touch panel, operation buttons, and a microphone, and transfers data input through the touch panel, the operation buttons, or the microphone to the CPU 810. The output unit 850 includes a display and a speaker, and outputs data from the CPU 810 through the display or the speaker. The CPU 810 executes predetermined processes prescribed by programs based on programs and data stored in the memory 820, data input to the communication unit 830 from an external device, and data input through the input unit 840. The CPU 810 stores execution result data in the memory 820, outputs the execution result data from the communication unit 830 to the external device, and outputs the execution result data through the output unit 850.

In the reservation system I for each charging device 30 for charging the battery 11 of the electrified vehicle 10, the charging device 30 may be installed in a parking lot for use of the shop 20 (for example, a car dealer, a beauty salon, an aesthetic salon, a hospital, a dental clinic, or an acupuncture and moxibustion clinic). In the case of such a shop 20, the worker 201 is assigned as a specific service representative to the user 101 who is a customer. In such a situation, the user 101 may want to receive a service (for example, vehicle checkup and maintenance, a haircut, a permanent wave, an aesthetic clinic, treatment, or acupuncture and moxibustion) from or have communication (for example, a business negotiation for vehicles or a consultation on services) with the worker 201 of the shop 20 in conjunction with the reservation for the charging device 30.

In view of the above, the reservation system 1 includes a first processing unit, a second processing unit, and a third processing unit. The first processing unit manages reservation time frames of the charging device 30 available to the user 101 of the shop 20. The second processing unit manages service providing time frames of the worker 201 who provides a service to the user 101 at the shop 20. The third processing unit executes a process for receiving a time frame of reservation desired by the user 101 among time frames overlapping between available reservation time frames and available providing time frames based on the reservation time frames of the charging device 30 managed by the first processing unit and the service providing time frames of the worker 201 managed by the second processing unit.

Thus, the time frame of reservation desired by the user 101 among the time frames overlapping between the available reservation time frames and the available providing time frames is received based on the managed reservation time frames of the charging device 30 and the managed service providing time frames of the worker 201. According to the reservation system 1, it is possible for the worker 201 of the shop 20 to provide the service to the user 101 in conjunction with the charging of the vehicle 10.

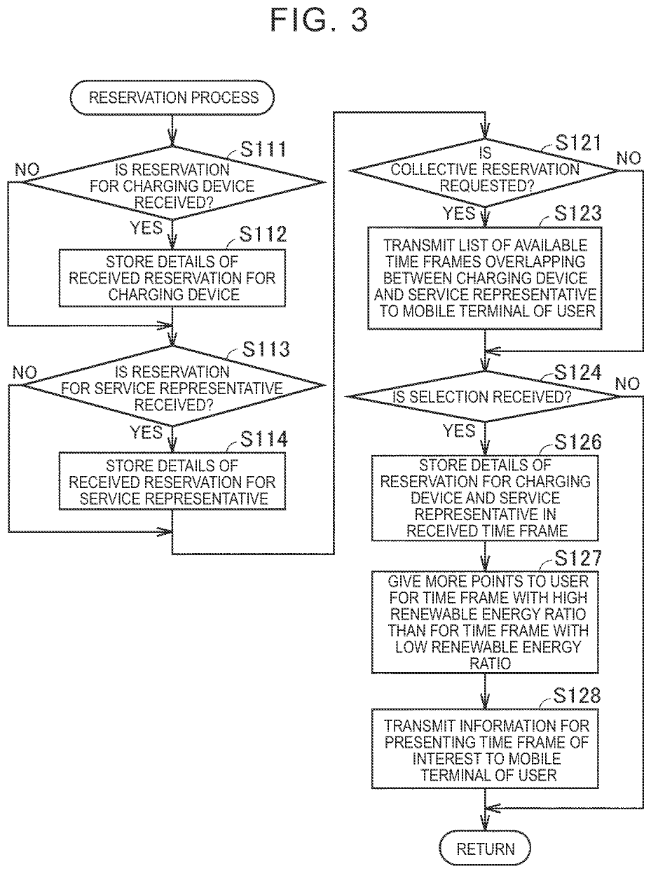

FIG. 3 is a flowchart showing a flow of a reservation process in the first embodiment. Referring to FIG. 3, the reservation process is called and executed by the shop server 200 from a higher-order process in every predetermined cycle.

First, the CPU 210 of the shop server 200 determines whether a reservation for the charging device 30 is received from the outside via the communication network 900 and the communication unit 230 (step S111). The outside may be, for example, the mobile terminal 800 of the user 101 or the vehicle 10 of the user 101. The reservation for the charging device 30 may be received regarding, as the outside, an input unit such as a keyboard or a mouse selectively provided in the shop server 200.

When determination is made that the reservation for the charging device 30 is received (YES in step S111), the CPU 210 stores details of the received reservation for the charging device 30 in the memory 220 or the mass storage device 240 (step S112).

When determination is made that the reservation for the charging device 30 is not received (NO in step S111) or after step S112, the CPU 210 determines whether a reservation for a service to be provided by the worker 201 serving as a service representative of the shop 20 is received from the outside via the communication network 900 and the communication unit 230 (step S113). The outside may be, for example, the mobile terminal 800 of the user 101 or the vehicle 10 of the user 101. The reservation for the service representative may be received regarding, as the outside, the input unit such as a keyboard or a mouse selectively provided in the shop server 200.

When determination is made that the reservation for the service representative is received (YES in step S113), the CPU 210 stores details of the received reservation for the service representative in the memory 220 or the mass storage device 240 (step S114).

When determination is made that the reservation for the service representative is not received (NO in step S113) or after step S114, the CPU 210 determines whether a request for a collective reservation for the charging device 30 and the service to be provided by the worker 201 serving as the service representative of the shop 20 is received from the outside via the communication network 900 and the communication unit 230 (step S121). The outside may be, for example, the mobile terminal 800 of the user 101 or the vehicle 10 of the user 101. The request for the collective reservation may be received regarding, as the outside, the input unit such as a keyboard or a mouse selectively provided in the shop server 200.

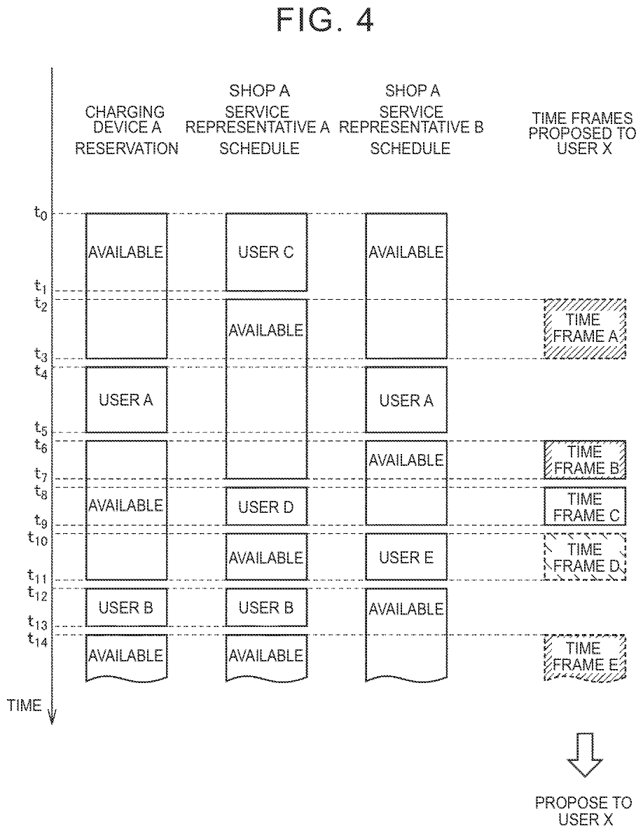

When determination is made that the request for the collective reservation is received (YES in step S121), the CPU 210 transmits, to the mobile terminal 800 of the user 101 (or the vehicle 10), information on a list of available time frames overlapping between the charging device 30 and the service representative (for example, information for displaying an image including a list shown in FIG. 4) (step S123).

FIG. 4 shows an example of the image including the list of available time frames overlapping between the charging device 30A and the service representatives in the embodiments. In FIG. 4, the image includes an image showing current reservation time frames of the charging device 30A whose name is “charging device A”, an image showing service providing time frames in a current schedule of a service representative A (worker 201A) of the shop 20A whose shop name is “shop A”, an image showing service providing time frames in a current schedule of a service representative B (worker 201B) of the “shop A”, and an image showing a list of available time frames overlapping between the charging device 30A and the service representative A or B proposed to a user X (user 101A).

In the image showing the current reservation time frames of the charging device 30A whose name is “charging device A”, the charging device 30A has an available time frame from time t₀ to time t₃, an interval time frame from time t₃ to time t₄, a time frame reserved by a user A from time t₄ to time t₅, an interval time frame from time t₅ to time t₆, an available time frame from time t₆ to time t₁₁, an interval time frame from time t₁ to time t₁₂, a time frame reserved by a user B from time t₁₂ to time t₁₃, an interval time frame from time t₁₃ to time t₁₄, and an available time frame after time t₁₄.

In the image showing the current reservation time frames of the worker 201A serving as the “service representative A”, the worker 201A has a time frame reserved by a user C from time t₀ to time t₁, an interval time frame from time t₁ to time t₂, an available time frame from time t₂ to time t₇, an interval time frame from time t₇ to time t₈, a time frame reserved by a user D from time t₅ to time t₉, an interval time frame from time t₉ to time t₁₀, an available time frame from time t₁₀ to time t₁₁, an interval time frame from time t₁₁ to time t₁₂, a time frame reserved by the user B from time t₁₂ to time t₁₃, an interval time frame from time t₁₃ to time t₁₄, and an available time frame after time t₁₄.

In the image showing the current reservation time frames of the worker 201B serving as the “service representative B”, the worker 201B has an available time frame from time t₀ to time t₃, an interval time frame from time t₃ to time t₄, a time frame reserved by the user A from time t₄ to time t₅, an interval time frame from time t₅ to time t₆, an available time frame from time t₆ to time t₉, an interval time frame from time t₉ to time t₁₀, a time frame reserved by a user E from time t₁₀ to time t₁₁, an interval time frame from time t₁₁ to time t₁₂, and an available time frame after time t₁₂.

In the image showing the list of available time frames overlapping between the charging device 30A and the service representative A or B proposed to the user X (user 101A), the list includes a proposed time frame A from time t₂ to time t₃, a proposed time frame B from time t₆ to time t₇, a proposed time frame C from time t₈ to time t₉, a proposed time frame D from time t₁₀ to time t₁₁, and a proposed time frame E after time t₁₄.

As indicated by the time frames A, B, and E, the box of each time frame is expressed in pattern 1 with an intense color (dense hatching in the figure) in the case of a time frame in which both the service representative A who usually serves the user X and the substitute service representative B who does not usually serve the user X are available.

As indicated by the time frame D, the box of the time frame is expressed in pattern 2 with a paler color than that of pattern 1 (sparser hatching in the figure than that of pattern 1) in the case of a time frame in which the service representative A who usually serves the user X is available and the substitute service representative B who does not usually serve the user X is not available.

As indicated by the time frame C, the box of the time frame is expressed in pattern 3 with a paler color than that of pattern 2 (no hatching in the figure) in the case of a time frame in which the service representative A who usually serves the user X is not available and the substitute service representative B who does not usually serve the user X is available.

As indicated by the time frames A, D, and E, when the service representative A who usually serves the user X has an appointment immediately before the appointment for the user X and the schedule may be changed with a relatively strong possibility, each time frame is enclosed by a dashed line to indicate a relatively low certainty of the schedule.

As indicated by the time frames B and C, when the service representative A who usually serves the user X has no appointment immediately before the appointment for the user X and the possibility of schedule change is lower than that in the case where each time frame is enclosed by the dashed line, each time frame is enclosed by a continuous line to indicate a higher certainty of the schedule than that in the case where each time frame is enclosed by the dashed line.

The screen shown in FIG. 4 is displayed on the display of the output unit 850 of the mobile terminal 800 of the user 101 or the display of the HMI 15 of the vehicle 10. With the display patterns such as colors and lines for the box of each time frame, the user can be notified about information indicating whether the usual service representative is available in that time frame and about the certainty of service provision by the service representative in that time frame.

Returning to FIG. 3, the CPU 210 of the shop server 200 determines whether selection of a time frame desired by the user 101 from the list shown in FIG. 4 is received from the mobile terminal 800 (or the vehicle 10) (step S124).

When determination is made that the selection is received (YES in step S124), the CPU 210 stores details of the reservation for the charging device 30 and the service representative in the received time frame (time frame of interest) in the memory 220 or the mass storage device 240 (step S126).

Next, the CPU 210 gives points to the user 101 based on the reserved time frame of interest so that more points are given to the user 101 for a time frame with a high renewable energy ratio (first time frame) than for a time frame with a low renewable energy ratio (step S127).

The CPU 210 transmits information for presenting the reserved time frame of interest to the mobile terminal 800 (or the vehicle 10) of the user 101 (step S128). Based on this information, an image for presenting the time frame of interest to the user 101 is displayed on the display of the output unit 850 of the mobile terminal 800 (or the HMI 15 of the vehicle 10).

When determination is made that the selection is not received (NO in step S124) or after step S128, the CPU 210 returns the process to be executed to the higher-order process of the caller of the current process.

### Second Embodiment

In the first embodiment, the shop server 200 executes the process for a reservation. In the second embodiment, the shop server 200 and the management server 100 for the charging device 30 execute processes for a reservation.

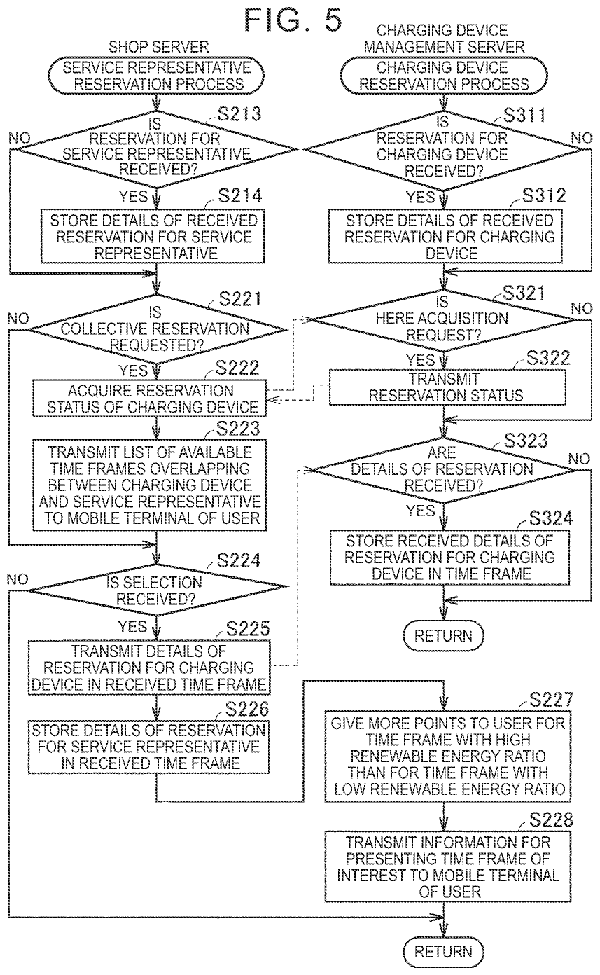

FIG. 5 is a flowchart showing flows of a service representative reservation process and a charging device reservation process in the second embodiment. Referring to FIG. 5, the service representative reservation process is called and executed by the shop server 200 from a higher-order process in every predetermined cycle. The charging device reservation process is called and executed by the management server 100 from a higher-order process in every predetermined cycle.

First, the CPU 110 of the management server 100 determines whether a reservation for the charging device 30 is received from the outside via the communication network 900 and the communication unit 130 (step S311). The outside may be, for example, the mobile terminal 800 of the user 101 or the vehicle 10 of the user 101. The reservation for the charging device 30 may be received regarding, as the outside, the input unit such as a keyboard or a mouse selectively provided in the shop server 200.

When determination is made that the reservation for the charging device 30 is received (YES in step S311), the CPU 110 stores details of the received reservation for the charging device 30 in the memory 120 or the mass storage device 140 (step S312).

The CPU 210 of the shop server 200 determines whether a reservation for a service to be provided by the worker 201 serving as a service representative of the shop 20 is received from the outside via the communication network 900 and the communication unit 230 (step S213). The outside may be, for example, the mobile terminal 800 of the user 101 or the vehicle 10 of the user 101. The reservation for the service representative may be received regarding, as the outside, the input unit such as a keyboard or a mouse selectively provided in the shop server 200.

When determination is made that the reservation for the service representative is received (YES in step S213), the CPU 210 stores details of the received reservation for the service representative in the memory 220 or the mass storage device 240 (step S214).

When determination is made that the reservation for the service representative is not received (NO in step S213) or after step S214, the CPU 210 determines whether a request for a collective reservation for the charging device 30 and the service to be provided by the worker 201 serving as the service representative of the shop 20 is received from the outside via the communication network 900 and the communication unit 230 (step S221). The outside may be, for example, the mobile terminal 800 of the user 101 or the vehicle 10 of the user 101. The request for the collective reservation may be received regarding, as the outside, the input unit such as a keyboard or a mouse selectively provided in the shop server 200.

When determination is made that the request for the collective reservation is received (YES in step S221), the CPU 210 acquires a reservation status of the charging device 30 from the management server 100 (step S222). Specifically, a request to acquire the reservation status of the charging device 30 is first transmitted to the management server 100.

When determination is made that the reservation for the charging device 30 is not received (NO in step S311) or after step S312, the CPU 110 of the management server 100 determines whether the acquisition request is received from the shop server 200 (step S321). When determination is made that the acquisition request is received (YES in step S321), the CPU 110 reads the reservation status of the charging device 30 from the memory 120 or the mass storage device 140, and transmits it to the shop server 200 (step S322).

The CPU 210 of the shop server 200 receives the reservation status of the charging device 30 from the management server 100. Thus, the shop server 200 acquires the reservation status of the charging device 30.

After step S222, the CPU 210 transmits, to the mobile terminal 800 of the user 101 (or the vehicle 10), information on a list of available time frames overlapping between the charging device 30 and the service representative (for example, information for displaying the image including the list shown in FIG. 4) (step S223).

The CPU 210 determines whether selection of a time frame desired by the user 101 from the list shown in FIG. 4 is received from the mobile terminal 800 (or the vehicle 10) (step S224).

When determination is made that the selection is received (YES in step S224), details of the reservation for the charging device 30 in the received time frame are transmitted to the management server 100 (step S225).

The CPU 110 of the management server 100 determines whether the details of the reservation for the charging device 30 are received from the shop server 200 via the communication network and the communication unit 130 (step S323). When determination is made that the details of the reservation for the charging device 30 are received (YES in step S323), the received details of the reservation for the charging device 30 in the time frame are stored in the memory 120 or the mass storage device 140 (step S324).

When determination is made that the details of the reservation for the charging device 30 are not received (NO in step S323) or after step S324, the CPU 110 returns the process to be executed to the higher-order process of the caller of the charging device reservation process.

After step S225, the CPU 210 of the shop server 200 stores details of the reservation for the service representative in the received time frame (time frame of interest) in the memory 220 or the mass storage device 240 (step S226).

Next, the CPU 210 gives points to the user 101 based on the reserved time frame of interest so that more points are given to the user 101 for a time frame with a high renewable energy ratio (first time frame) than for a time frame with a low renewable energy ratio (step S227).

The CPU 210 transmits information for presenting the reserved time frame of interest to the mobile terminal 800 (or the vehicle 10) of the user 101 (step S228). Based on this information, an image for presenting the time frame of interest to the user 101 is displayed on the display of the output unit 850 of the mobile terminal 800 (or the HMI 15 of the vehicle 10).

When determination is made that the selection is not received (NO in step S224) or after step S228, the CPU 210 returns the process to be executed to the higher-order process of the caller of the service representative reservation process.

### Modifications

(1) In the above embodiments, the interval time frame is provided between two reservation time frames as shown in FIG. 4. However, the present disclosure is not limited to this, and the interval time frame may be zero, that is, no interval time frame may be provided.
(2) In the first embodiment, as shown in FIG. 3, the CPU 210 of the shop server 200 implements all of the first processing unit that manages the reservation time frames of the charging device available to the user of the shop, the second processing unit that manages the service providing time frames of the service representative who provides a service to the user at the shop, and the third processing unit that executes the process for receiving a time frame of reservation desired by the user among the time frames overlapping between the available reservation time frames and the available providing time frames based on the reservation time frames of the charging device managed by the first processing unit and the service providing time frames of the service representative managed by the second processing unit.

In the second embodiment, as shown in FIG. 5, the CPU 210 of the shop server 200 implements the second processing unit and the third processing unit, and the CPU 110 of the management server 100 implements the first processing unit.

That is, all of the first processing unit, the second processing unit, and the third processing unit may be implemented by the same processor. The first processing unit may be implemented by a first processor, and the second processing unit and the third processing unit may be implemented by a second processor. However, the present disclosure is not limited to this, and the first processing unit, the second processing unit, and the third processing unit may be implemented by any processor. For example, all of the first processing unit, the second processing unit, and the third processing unit may be implemented by different processors. The first processing unit and the third processing unit may be implemented by the first processor, and the second processing unit may be implemented by the second processor.
(3) In the above embodiments, the mobile terminal 800 including the CPU 810 and the touch panel serving as the input unit 840 and the output unit 850 is a notification device for reservation as shown in FIGS. 1 to 5. However, the present disclosure is not limited to this, and any other device may be used as long as it is the notification device for reservation. The notification device may be, for example, the vehicle 10 including the ECU 12 and the HMI 15, or a personal computer (PC) including a CPU, a keyboard (and a mouse), and a display.
(4) In the above embodiments, as shown in FIGS. 1 to 5, the mobile terminal 800 including the touch panel serving as the input unit 840 and the output unit 850 is the notification device that notifies the user 101 of the shop 20 about time frames overlapping between the reservable time frames of the charging device 30 for the electrified vehicle (vehicle 10) available to the user 101 and the service providable time frames of the service representative (worker 201) who provides a service to the user 101 at the shop 20.

However, the configuration for notification about the time frame and reception of selection of the time frame is not limited to the touch panel. For example, the configuration for notification about the time frame may be a speaker gives a voice notification (for example, a voice message “The charging device is available in a time frame from time X to time Y and you can receive a service from a service representative at the shop.”). The configuration for reception of selection of the time frame may be a microphone that receives the selection by voice. In a case of a PC instead of the mobile terminal 800, the configuration for reception of selection of the time frame may be a mouse or a keyboard that receives an input by the hands of the user 101. In a case of a device including a camera, the configuration for reception of selection of the time frame may be a camera that captures an image of a gesture.
(5) The above embodiments can be regarded as disclosure of the reservation system 1, the shop server 200, the management server 100, the vehicle 10, or the mobile terminal 800, and can be regarded also as disclosure of a reservation processing method or a reservation processing program to be executed by the reservation system 1, the shop server 200, the management server 100, the vehicle 10, or the mobile terminal 800.

### SUMMARY

(1) As shown in FIGS. 1 to 5, the reservation system 1 is a system configured to make a reservation for the charging device 30 configured to charge the vehicle 10. The reservation system 1 includes the first processing unit (for example, the CPU 210 of the shop server 200, steps S111, S112 in FIG. 3, the CPU 110 of the management server 100, and steps S311, S312 in FIG. 5) configured to manage the reservation time frames of the charging device 30 available to the user 101 of the shop 20, the second processing unit (for example, the CPU 210 of the shop server 200, steps S113, S114 in FIG. 3, and steps S213, S214 in FIG. 5) configured to manage the providing time frames of a service from the service representative (worker 201) who provides the service to the user 101 at the shop 20, and the third processing unit (for example, the CPU 210 of the shop server 200, steps S121 to S128 in FIG. 3, and steps S221 to S228, S321 to S324 in FIG. 5) configured to execute the process for receiving a time frame of reservation desired by the user among the time frames overlapping between the available reservation time frames and the available providing time frames based on the reservation time frames of the charging device managed by the first processing unit and the providing time frames of the service from the service representative managed by the second processing unit.

Thus, the time frame of reservation desired by the user 101 among the time frames overlapping between the available reservation time frames and the available providing time frames is received based on the managed reservation time frames of the charging device 30 and the managed providing time frames of the service from the service representative (worker 201). As a result, the reservation system I can be used to provide the service from the service representative (worker 201) of the shop 20 to the user 101 in conjunction with the charging of the vehicle 10.
(2) As shown in FIGS. 3 and 5, the third processing unit may execute the process for presenting a list of the time frames overlapping between the available reservation time frames and the available providing time frames to the user (for example, step S123 in FIG. 3 and step S223 in FIG. 5), the process for receiving selection of a time frame desired by the user from the list (for example, step S124 in FIG. 3 and step S224 in FIG. 5), and the process for presenting the selected time frame to the user as the reservation time frame and the providing time frame (for example, step S128 in FIG. 3 and step S228 in FIG. 5).

Thus, the reservation system I can be used to appropriately provide the service from the service representative (worker 201) of the shop 20 to the user 101 in conjunction with the charging of the vehicle 10.
(3) As shown in FIG. 4, the third processing unit may execute the process for presenting the providing time frame in which the service is providable by the service representative desired by the user in the list in a manner different from the manner for the providing time frame in which the service is providable by another service representative. Examples of the different manner include a manner in which the color in the box of an image showing the time frame differs in lightness, hue, or saturation.

Thus, the time frame in which the service is providable by the service representative (worker 201) desired by the user 101 and the time frame in which the service is providable by another service representative can be presented to the user 101 while being distinguished clearly.
(4) As shown in FIG. 4, the third processing unit may execute the process for presenting the providing time frame in which the service is providable by the service representative (worker 201) desired by the user 101 in the list in a manner that is based on the certainty of service provision in the providing time frame. Examples of the manner that is based on the certainty include the use of a continuous line to enclose the box of the time frame in a case of a high certainty and the use of a dashed line to enclose the box of the time frame in a case of a lower certainty than in the former case.

Thus, it is possible to present to the user 101 whether the service is reliably providable in the providing time frame in which the service is providable by the service representative (worker 201) desired by the user 101.
(5) As shown in FIGS. 3 and 5, a fourth processing unit (for example, the CPU 210 of the shop server 200, step S127 in FIG. 3, the CPU 110 of the management server 100, and step S227 in FIG. 5) may further be provided to execute the process for giving more points to the user in a case where selection of a time frame with a higher renewable energy ratio than the renewable energy ratio in another time frame from the list is received from the user than in a case where the selection of the time frame with the higher renewable energy ratio is not received.

Thus, it is possible to prompt the user 101 to make a reservation for the time frame with the higher renewable energy ratio.

The embodiments disclosed herein should be considered to be illustrative in all respects and not restrictive. The scope of the present disclosure is shown by the claims rather than by the above description of the embodiments, and is intended to include all modifications within the meaning and scope equivalent to the claims.

What is claimed is:

1. A reservation system configured to make a reservation for a charging device configured to charge a vehicle, the reservation system comprising:
a first processing unit configured to manage reservation time frames of the charging device available to a user of a shop;
a second processing unit configured to manage providing time frames of a service from a service representative who provides the service to the user at the shop; and
a third processing unit configured to execute a process for receiving a time frame of reservation desired by the user among time frames overlapping between available reservation time frames and available providing time frames based on the reservation time frames of the charging device managed by the first processing unit and the providing time frames of the service from the service representative managed by the second processing unit.

2. The reservation system according to claim 1, wherein the third processing unit is configured to execute a process for presenting a list of the time frames overlapping between the available reservation time frames and the available providing time frames to the user, a process for receiving selection of a time frame desired by the user from the list, and a process for presenting a selected time frame to the user as the reservation time frame and the providing time frame.

3. The reservation system according to claim 2, wherein the third processing unit is configured to execute a process for presenting the providing time frame in which the service is providable by a service representative desired by the user in the list in a manner different from a manner for the providing time frame in which the service is providable by another service representative.

4. The reservation system according to claim 2, wherein the third processing unit is configured to execute a process for presenting the providing time frame in which the service is providable by a service representative desired by the user in the list in a manner that is based on a certainty of provision of the service in the providing time frame.

5. The reservation system according to claim 2, further comprising a fourth processing unit configured to execute a process for giving more points to the user in a case where selection of a first time frame with a higher renewable energy ratio than a renewable energy ratio in another time frame from the list is received from the user than in a case where the selection of the first time frame is not received from the user.

6. A notification device configured to notify a user of a shop about time frames overlapping between reservable time frames of a charging device for an electrified vehicle available to the user and providable time frames of a service from a service representative who provides the service to the user at the shop.

7. The notification device according to claim 6, wherein the notification device is configured to give a notification about the providable time frame in which the service is providable by a service representative desired by the user in a manner different from a manner for the providable time frame in which the service is providable by another service representative.

8. The notification device according to claim 6, wherein the notification device is configured to give a notification about the providable time frame in which the service is providable by a service representative desired by the user in a manner that is based on a certainty of provision of the service in the providable time frame.

9. A reservation method in a reservation system including at least one computer configured to make a reservation for a charging device configured to charge a vehicle, the reservation method comprising:
managing, by the at least one computer, reservation time frames of the charging device available to a user of a shop;
managing, by the at least one computer, providing time frames of a service from a service representative who provides the service to the user at the shop; and
executing, by the at least one computer, a process for receiving a time frame of reservation desired by the user among time frames overlapping between available reservation time frames and available providing time frames based on the managed reservation time frames of the charging device and the managed providing time frames of the service from the service representative.

10. The reservation method according to claim 9, wherein the at least one computer is configured to, as the process for receiving the time frame of reservation desired by the user, execute a process for presenting a list of the time frames overlapping between the available reservation time frames and the available providing time frames to the user, a process for receiving selection of a time frame desired by the user from the list, and a process for presenting a selected time frame to the user as the reservation time frame and the providing time frame.

11. The reservation method according to claim 10, wherein the at least one computer is configured to, as the process for presenting the list to the user, execute a process for presenting the providing time frame in which the service is providable by a service representative desired by the user in the list in a manner different from a manner for the providing time frame in which the service is providable by another service representative.

12. The reservation method according to claim 10, wherein the at least one computer is configured to, as the process for presenting the list to the user, execute a process for presenting the providing time frame in which the service is providable by a service representative desired by the user in the list in a manner that is based on a certainty of provision of the service in the providing time frame.

13. The reservation method according to claim 10, further comprising executing, by the at least one computer, a process for giving more points to the user in a case where selection of a first time frame with a higher renewable energy ratio than a renewable energy ratio in another time frame from the list is received from the user than in a case where the selection of the first time frame is not received from the user.
